(19) United States
(12) Patent Application Publication
(10) Pub. No.: US 2005/0074202 A1
(43) Pub. Date: Apr. 7, 2005

(54) Optical path switching device and add/drop optical switch

(76) Inventors: Takayuki Ojima, Kanagawa-ken (JP); Kentaro Harase, Kanagawa-ken (JP); Yoshio Kawai, Saitama-ken (JP); Hideharu Kajizuka, Kanagawa-ken (JP); Takurou Horinaka, Kanagawa-ken (JP); Atsuo Ishi, Kanagawa-ken (JP)

Correspondence Address: TAKEUCHI & TAKEUCHI, Suite 310, 1700 Diagonal Road, Alexandria, VA, 22314, US

(21) Appl. No.: 10/947,321

(22) Filed: Sep. 23, 2004

(30) Foreign Application Priority Data
Oct. 31, 2003 (JP) 2003-372982
Oct. 3, 2003 (JP) 2003-345100
Oct. 31, 2003 (JP) 2003-372979

(51) Int. Cl. G02B 6/26

(52) U.S. Cl. 385/18; 385/25

(57) ABSTRACT

An optical switch for switching an optical path includes a fixed reflection element disposed at each of crossing points of a plurality of lines and a plurality of redundant lines for switching the optical path to one of the redundant lines, and a movable optical unit disposed at each of the crossing points and including an optical path parallel move element. The optical path parallel move element has parallel surfaces for moving the optical path in parallel toward the fixed reflection element. The movable optical unit located on the optical path of one of collimators moves in and out the optical path incident from an auxiliary collimator to switch the optical path when the one of the collimators has a problem.

### BACKGROUND OF THE INVENTION

1. Field of the Invention

The present invention relates to an optical switching device and an add/drop optical switch, in which it is possible to relax dimensional tolerance as opposed to stringent machining accuracy, positioning, and angle requirements of a conventional optical element and a conventional driving device. The present invention relates to an optical switch with low cost, low loss and high yield.

2. Description of the Related Art

FIG. 8 shows a conventional optical switch which includes a base plate 7′ provided with input collimators 17′ and output collimators 18′ thereon. A movable reflection mirror 9′ connected to a drive device moves in and out a crossing point of an input optical path and an output optical path to perform an optical switching operation (refer to ‘10×10 prototype matrix optical switch’ Yamamoto et al., Densitsushin Gakkaisi, vol. J64-C, No. 12, p. 819-826 (1981)).

In the conventional optical switch, as shown in FIG. 8, a reflection element such as the movable reflection mirror 9′ moves. Accordingly, it is necessary to machine the element with high accuracy. Further, it is necessary to position the element with high precision at a precise angle.

An object of the present invention is to provide an optical switch in which it is possible to relax stringent requirements of an optical element and a driving device in machining accuracy, positioning, and angles. Another object of the present invention is to provide an add/drop optical switch in which it is possible to relax dimensional tolerance of an optical element and a driving device in machining accuracy, positioning, and angles.

### SUMMARY OF THE INVENTION

In order to attain the objects described above, according to a first aspect of the present invention, an optical switch includes a fixed reflection element disposed at each of crossing points of a plurality of lines (M) and a plurality of redundant lines (N) for switching an optical path to one of the redundant lines, and a first optical path parallel move element disposed at each of the crossing points and having parallel surfaces for moving the optical path in parallel toward the fixed reflection element. When one of collimators (B) has a problem, a movable optical unit on a path of the collimator moves in and out an optical path incident from an auxiliary collimator to switch the optical path.

According to a second aspect of the present invention, an optical switch includes fixed reflection elements disposed at crossing points of a plurality of lines (M) and a plurality of redundant lines (N) for switching optical paths to the redundant lines, and a plurality of optical movable units (N) disposed at predetermined ones of the crossing points of a plurality of lines (M) and a plurality of redundant lines (N). Each of the movable optical units includes a first optical path parallel move element having parallel surfaces for moving the optical path in parallel toward the fixed reflection element, and a second optical path parallel move element having parallel surfaces for moving the optical path in parallel toward a position different from a reflection point of the fixed reflection element after the optical path is moved by the first optical path parallel move element and switched by the fixed reflection element. When one of collimators (B) has a problem, one of the movable optical units on a path of the collimator moves in and out an optical path incident from an auxiliary collimator to switch the optical path.

According to a third aspect of the present invention, an optical switch includes the optical movable unit according to the first aspect. When one of collimators (B) has a problem, the movable optical unit is disposed on a path of the collimator, and moves in and out an optical path incident from an auxiliary collimator to switch the optical path.

According to a fourth aspect of the present invention, an optical switch includes the movable optical unit according to the third aspect, and has a fixing member for fixing the movable optical unit to a specific crossing point.

According to a fifth aspect of the present invention, an optical switch includes the movable optical unit according to the fourth aspect, and has a projection for inserting into a hole disposed at the specific crossing point, so that the optical path parallel move element of the movable optical unit is fixed to a specific crossing point.

According to a sixth aspect of the present invention, in any one of the first to fifth aspects, when one of input collimators 2B at a B position has a problem, the movable optical unit moves vertically in and out an optical path incident from an auxiliary collimator and passing through the fixed reflection mirror disposed at a position different from the crossing point to switch the optical path.

According to a seventh aspect of the present invention, in the second aspect, the first optical path parallel move element receives light at a height substantially same as that of light output from the second optical path parallel move element.

According to an eighth aspect of the present invention, in any one of the first to seventh aspects, the fixed reflection element is disposed so that the optical path is bent substantially at the right angle.

According to a ninth aspect of the present invention, an optical switch includes a fixed reflection element for changing an angle of an optical path, an optical path parallel move element having a pair of parallel surfaces for moving the optical path in parallel toward the fixed reflection element, and driving means for moving the optical path parallel move element in parallel or rotating the same in and out an optical path to switch the optical path.

According to a tenth aspect of the present invention, an optical switch includes a fixed reflection element for changing an angle of an optical path, a first optical path parallel move element having a pair of parallel surfaces for moving the optical path in parallel toward the fixed reflection element, and a second optical path parallel move element having parallel surfaces for moving the optical path in parallel toward a position different from a reflection point of the fixed reflection element after the optical path is moved in parallel by the first optical path parallel move element and bent by the fixed reflection element. The driving means moves the first and second optical path parallel move elements in parallel or rotates the same in and out the optical path to switch the optical path.

According to an eleventh aspect of the present invention, in one of the ninth and tenth aspects, an optical path parallel move element unit having more than one optical path parallel move element receives and outputs light at the same height.

According to a twelfth aspect of the present invention, in one of the tenth and eleventh aspects, the driving devices of the first and second optical path parallel move elements are integrated as a single driving device.

According to a thirteenth aspect of the present invention, in any one of the ninth to twelfth aspects, the fixed reflection element is disposed so that the optical path is bent substantially at the right angle.

According to a fourteenth aspect of the present invention, in any one of the ninth to thirteenth aspects, an N number of the optical switches are disposed in a line to form a 1×N optical switch.

According to a fourteenth aspect of the present invention, in any one of the ninth to thirteenth aspects, an (M×N) number of the optical switches are disposed in a matrix pattern to form an M×N matrix optical switch.

According to a fifteenth aspect of the present invention, an add/drop optical switch includes fixed reflection elements disposed at crossing points of L pairs of opposite collimators formed of output collimators and input collimators, an M number of drop collimators, and an N number of Add collimators for changing angles of optical paths; and an (L×(M+N)) number of movable optical units disposed at the crossing points of the optical paths of the opposite collimators and the add collimators and drop collimators. Each of the movable optical units includes more than one optical path move elements having a pair of parallel surfaces. A driving device moves the movable optical units in and out the optical paths so that light from the input collimators is switched to the drop collimators, and light from the add collimators is switched to the output collimators.

According to a sixteenth aspect of the present invention, an add/drop optical switch includes fixed reflection elements disposed at crossing points of L pairs of opposite collimators formed of output collimators and input collimators, an M number of drop collimators, and an N number of Add collimators for changing angles of optical paths; and at least one movable optical unit disposed at one of the crossing points of the optical paths of the opposite collimators and the add collimators and drop collimators. The movable optical unit includes more than one optical path move elements having a pair of parallel surfaces. A driving device moves the movable optical unit in and out the crossing point of an optical path of the opposite collimators and an optical path of the add/drop collimators, so that light from the input collimators is switched to the drop collimators, and light from the add collimators is switched to the output collimators.

According to a seventeenth aspect of the present invention, in any one of the fifteenth to sixteenth aspects, the movable optical unit receives and outputs light at the same height.

According to an eighteenth aspect of the present invention, in any one of the fifteenth to sixteenth aspects, the fixed reflection element is disposed so that the optical path is bent substantially at the right angle.

As compared to a conventional optical switch requiring stringent machining accuracy, positioning and angles for the optical elements and the driving device, in the optical switch of the present invention, it is possible to relax the requirements, thereby reducing cost and loss and obtaining high yield. In the add/drop optical switch of the present invention, it is possible to drop (split) an optical signal from an input fiber to a specific drop fiber. Further, it is possible to add (insert) an optical signal from a specific add fiber to an output fiber.

### BRIEF DESCRIPTION OF THE DRAWINGS

FIGS. 1(a) to 1(c) are views showing optical switching devices according to embodiments of the present invention, wherein FIG. 1(a) is a view showing an optical switch 1A′, FIG. 1(b) is a view showing an optical switch 1B′, and FIG. 1(c) is a view showing an optical switch 1C′;

FIGS. 2(a) and 2(b) are views showing optical switches according to embodiments of the present invention, wherein FIG. 2(a) is a view showing an optical switch 1A in which an optical path 2 passes through a prism 3 and a mirror 4, and FIG. 2(b) is a view showing the optical switch 1A in which the optical path 2 proceeds straight without passing through the prism 3 and the mirror 4;

FIGS. 3(a) to 3(f) are views showing optical switches according to embodiments of the present invention, wherein FIG. 3(a) is a view showing an optical switch 1B in which the optical path 2 passes through the prism 3 and the mirror 4, FIG. 3(b) is a view showing the optical switch 1B in which the optical path 2 proceeds straight without passing through the prism 3 and the mirror 4, FIG. 3(c) is a view showing the optical switch 1B in which the switch moves in parallel laterally and the optical path 2 passes through the prism 3 and the mirror 4, FIG. 3(d) is a view showing the optical switch 1B in which the switch moves in parallel laterally and the optical path 2 proceeds straight without passing through the prism 3A and the mirror 4, FIG. 3(e) is a view showing the optical switch 1B in which the switch moves rotationally and the optical path 2 passes through the prism 3 and the mirror 4, and FIG. 3(f) is a view showing the optical switch 1B in which the switch moves rotationally and the optical path 2 proceeds straight without passing through the prism 3 and the mirror 4;

FIG. 4 is a perspective view showing an optical switch 1F according to the present invention in which an N number of the optical switches are arranged in line to form an (1×N) optical switch so that light from an input collimator 17 is incident on an output collimator 18;

FIG. 5 a perspective view showing an optical switch 1G according to the present invention in which an M×N number of the optical switches are arranged in a (M×N) matrix pattern to form an (M×N) optical switch so that light from the input collimator 17 is incident on the output collimator 18;

FIG. 6(a) is a view showing an optical switch element 10 according to the present invention in which an optical path 2 passes through a prism 3 and a mirror 4, FIG. 6(b) is a view showing the optical switch element 10 according to the present invention in which the optical path 2 proceeds straight without passing through the prism 3 and the mirror 4, and FIG. 6(c) is a plan view showing an add/drop optical switch 1A according to the present invention;

FIG. 7 is a plan view showing an add/drop optical switch 1B according to the present invention; and

FIG. 8 is a view showing a conventional optical switch 1′ in which an optical path 2′ passes through a movable reflection mirror 9′.

### DETAILED DESCRIPTION OF PREFERRED EMBODIMENTS

Hereunder, embodiments of the present invention will be described with reference to the accompanied drawings. A conventional optical switch uses a movable reflection element requiring stringent positioning and angle accuracy, and a driving device is provided for each reflection element for moving the same. On the other hand, in an optical switch of the present invention, a reflection element is fixed, and an optical path move element requiring less stringent angle accuracy is moved in parallel or rotated. Further, a plurality of the optical switches is used to form a 1×N optical switch or an M×N matrix optical switch.

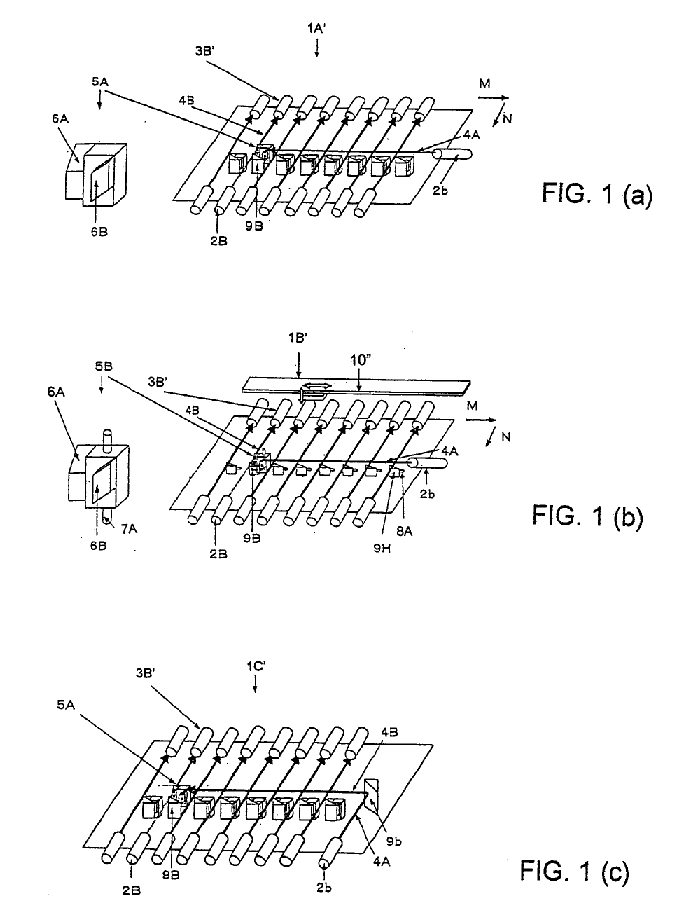

In a first embodiment of the present invention, a fixed reflection element and a movable optical unit are disposed on a base plate in advance. The first embodiment has a structure shown in FIG. 1(a), except that a second parallel move prism 6B is omitted. That is, the reflection element and a first optical path move element having parallel surfaces for moving an optical path in parallel are disposed. When there is no problem, the optical path moves from an input collimator to an output collimator. When a collimator located at a B-th position has a problem, the movable optical unit is moved vertically in and out an optical path incident from an auxiliary collimator to switch the optical path.

A second embodiment of the present invention will be explained with reference to FIG. 1(a). In the second embodiment, the fixed reflection element and the movable optical unit are disposed on the base plate in advance. The structure is provided with no fixing means, and the movable optical unit moves in and out the optical path to switch the optical path. In the embodiment, the movable optical unit 5A does not have a projection 7A, and is integrally formed of a first optical path parallel move prism 6A and a second optical path parallel move prism 6B. An N number of the movable optical units 5A are disposed in advance. When there is no problem, the optical path moves from an input collimator 2B to an output collimator 3B′. On the other hand, when an input collimator 2B located at a B-th position has a problem, the movable optical unit 5A is moved vertically in and out an optical path incident from an auxiliary input collimator 2b to switch the optical path.

Unlike the first and second embodiments, according to a third embodiment of the present invention, the movable optical unit is not disposed in advance. When the input collimator 2B located at a B-th position has a problem, without providing fixing means (projection 7′ and hole 8′ shown in FIG. 1(b)), in a state that a driving device moves the movable optical unit to a crossing point at the B-th position (without fixing), the movable optical unit moves in and out the optical path to switch the optical path.

According to a fourth embodiment of the present invention, in the movable optical unit with the integrated unit in the third embodiment, the fixing means is provided for fixing at a specific crossing point. The fixing means is typically formed of the projection 7′ and the hole 8′, and is not limited thereto.

FIG. 1(b) is a view showing an optical path switch according to a fifth embodiment of the present invention. A movable optical unit 5B is provided with the projection 7′ as the fixing means. The movable optical unit 5B is formed of the first optical path parallel move prism 6A, the second optical path parallel move prism 6B, and the projection 7′. In the fifth embodiment, when there is no problem, the optical path moves from the input collimator 2B to the output collimator 3B′. On the other hand, when the input collimator 2B located at the B-th position has a problem, the movable optical unit 5B is disposed at a location having the problem, and the driving device 10″ moves the movable optical unit 5B vertically in and out the optical path incident from the auxiliary input collimator 2b to switch the optical path.

In the embodiment, in order to connect the input collimator 2B to the output collimator 3B′, the driving device 10″ arranges the movable optical unit 5 at a specific position. Light incident from the auxiliary input collimator 2b passes through an optical path 4A, and changes the optical path through the second optical path parallel move prism 6B. After reflecting on a fixed reflection mirror 9B, the reflected light changes the optical path through the first optical path parallel move prism 6B. The incident light passes on an optical path 4B, and is incident on the output collimator 3B. In this case, the projection 7′ formed on the movable optical unit is inserted into the hole 8′ formed at a specific crossing point, so that the movable optical unit 5B is fixed to the hole 8 at the specific crossing point. After released from the driving device 10″, the movable optical unit 5B is fixed at the position with the projection 7′ inserted into the hole 8′ formed in the base plate 12.

A sixth embodiment of the present invention is shown in FIG. 1(c). According to the sixth embodiment, in one of the first to fifth embodiments, when the input collimator 2B located at the B-th position has a problem, the movable optical unit 5B moves vertically in and out the optical path incident from the auxiliary input collimator 2b and passing through a fixed reflection mirror 9b disposed at a position different from the crossing point to switch the optical path.

According to a seventh embodiment of the present invention, in one of the first to sixth embodiments, the first optical path parallel move element receives light at a height same as a height that the second optical path parallel move element outputs light.

According to an eighth embodiment of the present invention, in one of the first to seventh embodiments, the fixed reflection element is arranged such that the optical path is bent substantially at the right angle.

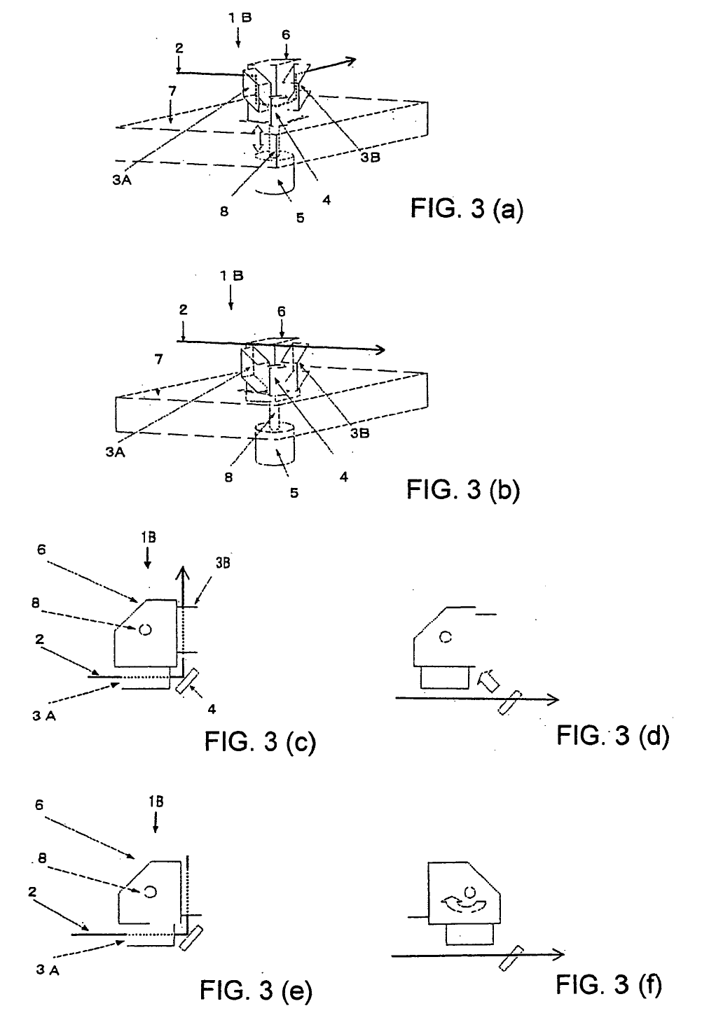

A ninth embodiment has a structure shown in FIG. 3(a), except that a second optical path move prism 3B is omitted. That is, a reflection element requiring stringent positioning and angle accuracy is fixed, and an optical path move element requiring less stringent positioning and angle accuracy is movable. An optical switch of the embodiment switches between two states. One is a state that the optical path move element is not located on an optical path and light proceeds straight. The other is a state that the driving device moves the optical path move element in parallel or rotates the same. In this case, light entering the optical path proceeds in parallel on the optical path, and switches the optical path after passing through the fixed reflection element. When it is not necessary to change the optical path from a reflection point of a fixed reflection mirror 4, it is not necessary to provide the second optical path move prism 3B.

The driving device moves the optical path move element through the parallel movement in the vertical direction as shown in FIGS. 3(a) and 3(b); through the parallel movement in the lateral direction as shown in FIGS. 3(c) and 3(d); or through the rotational movement as shown in FIGS. 3(e) and 3(f).

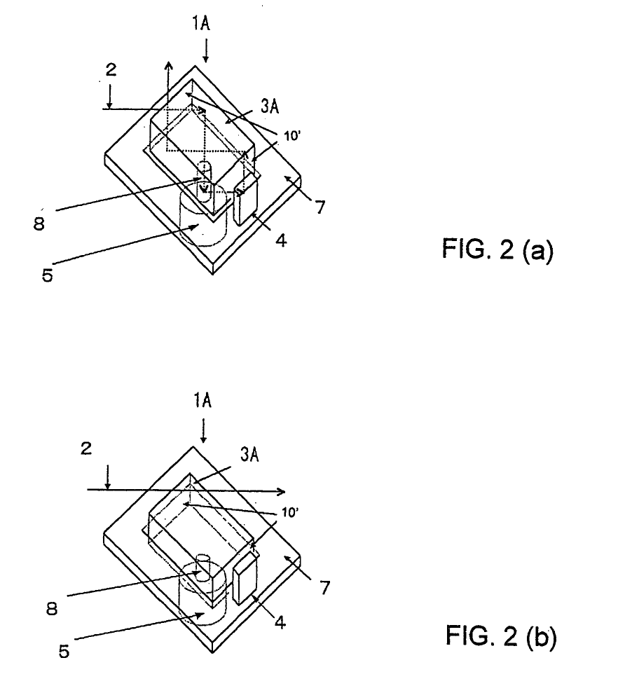

In the optical switch 1A of the ninth embodiment shown in FIGS. 2(a) and 2(b), the optical path 2 passes through a prism 3A and the mirror 4 as shown in FIG. 2(a), or the optical path proceeds straight without passing through the prism 3A and the mirror 4 as shown in FIG. 2(b). The optical switch 1A includes the movable optical path move prism 3A for moving the optical path in parallel; the fixed reflection mirror 4 for bending the optical path at the right angle; a driving solenoid 5 for moving the movable optical path move prism 3A; a shaft 8 for transmitting drive of the driving solenoid 5 to the movable optical path move prism 3A; and a base plate 7 for fixing the fixed reflection mirror 4.

An anti-reflection film 10′ is formed on a surface of the movable optical path move prism 3A through which light proceeds in and out. With such a structure, the optical path 2 is moved in parallel with the movable optical path move prism 3A, and is incident on the fixed reflection mirror 4. After changing the angle, the optical path 2 is incident on the movable optical path move prism 3A. Then, the optical path 2 is moved in parallel with the movable optical path move prism 3A, and is output. Accordingly, the optical path changes the direction from the reflection point of the fixed reflection mirror 4 with a single prism, i.e. the movable optical path move prism 3A. As described above, the driving device moves the optical path move element through the parallel movement in the vertical direction, the parallel movement in the lateral direction, or the rotational movement.

According to a tenth embodiment, the optical path 2 passes through the prisms 3A and 3B and the mirror 4 as shown in FIG. 3(a), or the optical path proceeds straight without passing through the prisms 3A and 3B and the mirror 4 as shown in FIG. 3(b). The optical switch 1B includes the first movable optical path move prism 3A for moving the optical path in parallel; the second movable optical path move prism 3B for moving the optical path in parallel; the fixed reflection mirror 4 for bending the optical path at the right angle; the driving solenoid 5 for integrally moving the first and second movable optical path move prisms 3A and 3B; a movable unit 6 for integrally fixing the first and second movable optical path move prisms 3A and 3B; the shaft 8 for transmitting drive of the driving solenoid 5 to the movable unit 6; and the base plate 7 for fixing the fixed reflection mirror 4.

With such a structure, the optical path 2 is moved in parallel with the first movable optical path move prism 3A, and is incident on the fixed reflection mirror 4. After changing the direction at the right angle, the optical path 2 is incident on the second movable optical path move prism 3B. Then, the optical path 2 is moved in parallel with the second movable optical path move prism 3B, and is output. At this time, the second movable optical path move prism 3B does not need to move the optical path in parallel from the fixed reflection mirror 4 to a height same as a height that the optical path is incident on the first movable optical path move prism 3A. As described above, the driving device moves the optical path move elements through the parallel movement in the vertical direction, the parallel movement in the lateral direction, or the rotational movement.

According to an eleventh embodiment, in the tenth embodiment, the second movable optical path move prism 3B moves the optical path in parallel passing through the fixed reflection mirror after changing the angle to a height same as a height that light enters the first movable optical path move prism 3A. Accordingly, light enters the switch at a height same as that of light outputting from the switch.

According to a twelfth embodiment, in the tenth or eleventh embodiment, the driving devices of the first and second movable prisms are integrated to from a single common driving device. The first and second movable optical path move prisms 3A and 3B are integrated with the movable unit 6. The shaft 8 transmits the drive of the driving device 5 to the movable unit 6 to move the same, so that the optical path is switched between the bend path and the straight path. The driving devices are integrated into one single common driving device. From a design point of view, the first and second movable optical path move prisms 3A and 3B may have separate driving devices, respectively. In the embodiment, the driving device is the solenoid, and may be a motor.

According to a thirteenth embodiment, in the optical switch of one of the ninth to twelfth embodiments, the fixed reflection element is arranged so that the optical path is bent at the right angle. It is preferred that the angle is the right angle, but not limited thereto.

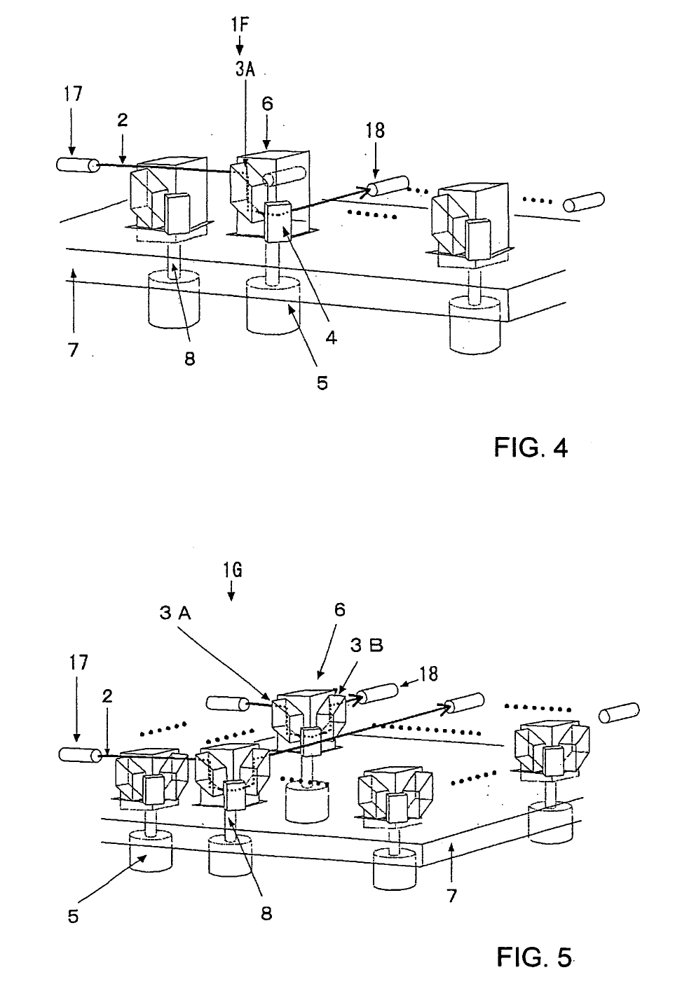

According to a fourteenth embodiment, the first movable optical path move prism 3A is arranged as shown in FIG. 4. An N number of the optical switches in one of the ninth to thirteenth embodiments are arranged in line to form a 1×N optical switch. One output collimator 17 outputs light along the N number of the optical switches arranged in a line. The switch enters the optical path to bend the same, and light is incident on a specific collimator among an N number of the output collimators 18. Note that it is not necessary to provide the second movable optical path move prism 3B for moving light in parallel reflected from the reflection mirror 4. When the N number of the switches do not enter the optical path, the N number of the switches function as a 1×(N+1) optical switch.

According to a fifteenth embodiment, the first and second movable optical path move prisms 3A and 3B are arranged as shown in FIG. 5. An M×N number of the optical switches in one of the ninth to thirteenth embodiments are arranged in an M×N matrix pattern to form an M×N optical switch. An M number of the output collimators 17 arranged in M lines corresponding to the M lines output light along the N number of the optical switches arranged in the M lines. The switches enter the optical path to bend the same, so that light is incident on a specific collimator among an N number of the output collimators 18 corresponding to the switches arranged in the N lines. At this time, light is incident on the output collimator 8 without passing through the adjacent reflection mirror with the second movable optical path move prism 3B that moves light in parallel reflected from the reflection mirror 4. An M number of opposite collimators may be provided to face the M number of the input collimators. An N number of opposite collimators may be provided to face the N number of the output collimators.

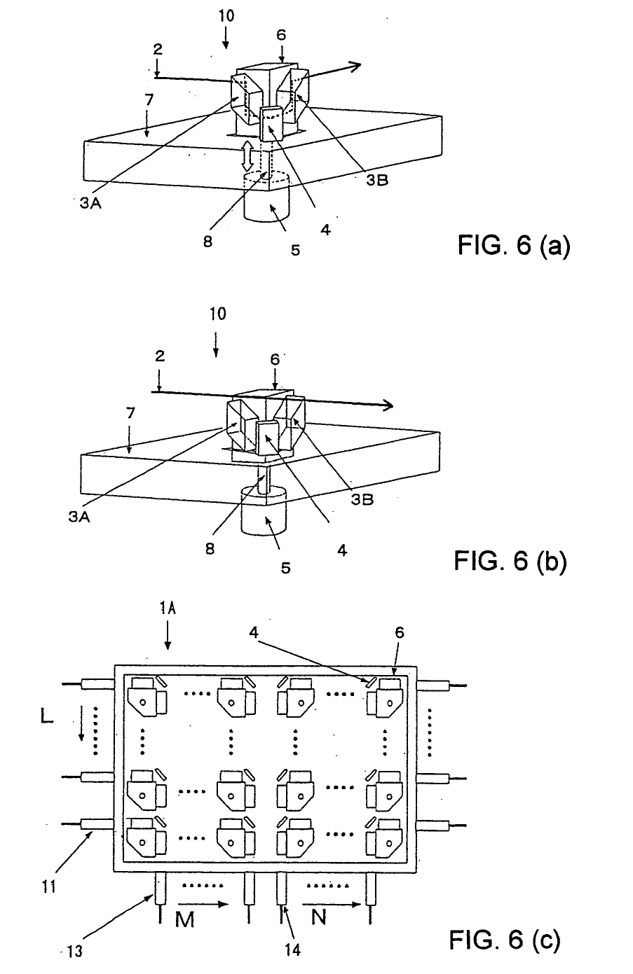

According to a sixteenth embodiment, as shown in FIG. 6(c), an add/drop optical switch 1A includes an (L×(M+N)) number of the optical switches disposed at crossing points. In an optical switch 10 shown in FIG. 6(a), the optical path 2 passes through the prisms 3A and 3B and the mirror 4, or the optical path 2 proceeds straight without passing through the prisms 3A and 3B and the mirror 4 as shown in FIG. 6(b).

As shown in FIGS. 6(a) and 6(b), the optical switch 10 includes the first movable optical path move prism 3A for moving the optical path in parallel; the second movable optical path move prism 3B for moving the optical path in parallel; the fixed reflection mirror 4 for bending the optical path at the right angle; the movable unit 6 integrated with the first and second movable optical path move prisms 3A and 3B; the driving solenoid 5 for moving the movable unit 6; the shaft 8 for transmitting drive of the driving solenoid 5; and the base plate 7 for fixing the fixed reflection mirror 4.

With such a structure, the optical path 2 is moved in parallel with the first movable optical path move prism 3A, and is incident on the fixed reflection mirror 4. After changing the direction at the right angle, the optical path 2 is incident on the second movable optical path move prism 3B. Then, the optical path 2 is moved in parallel with the second movable optical path move prism 3B, and is output. At this time, the second movable optical path move prism 3B does not need to move the optical path in parallel from the fixed reflection mirror 4 to a height same as a height that the optical path is incident on the first movable optical path move prism 3A.

In the sixteenth embodiment, an L number of opposing pairs of the input collimators 11 and the output collimators 12 are arranged next to each other. An M number of the drop collimators 13 and an N number of the add collimators 14 are arranged next to each other. An (L×(M+N)) number of the optical switches are disposed at the crossing points of a grid where light from the input collimators 11, the output collimators 12, the drop collimators 13, and the add collimators 14 passes through. The movable unit 6 disposed at a crossing point of the input and output collimators to be switched enters the optical path, so that light is reflected at the fixed reflection mirror 4 and switched to a specific output collimator.

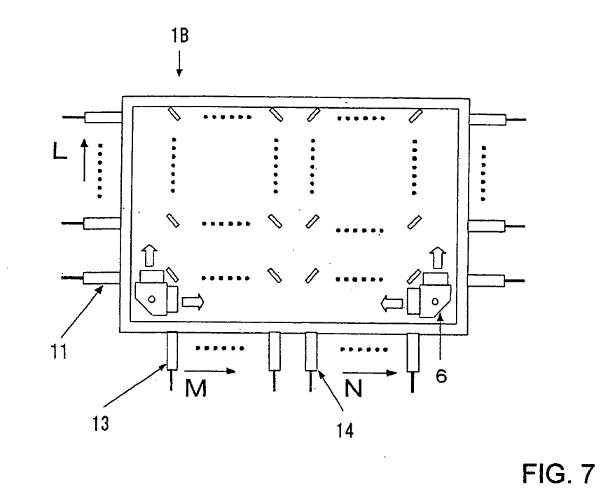

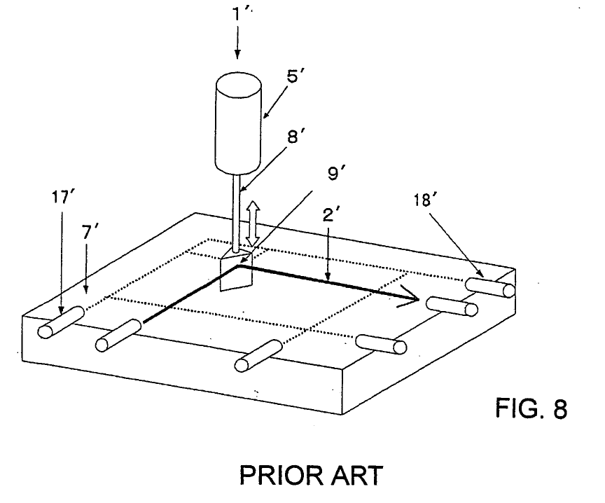

According to a seventeenth embodiment, as shown in FIG. 7, the movable unit is moved to each of the crossing points. An L number of opposing pairs of the input collimators 11 and the output collimators 12 are arranged next to each other. An M number of the drop collimators 13 and an N number of the add collimators 14 are arranged next to each other. An (L×(M+N)) number of the fixed reflection mirrors 4 are disposed at the crossing points of a grid where light from the input collimators 11, the output collimators 12, the drop collimators 13, and the add collimators 14 passes through. More than one of the movable units 6 and the driving devices for moving the movable units 6 to the crossing points are provided.

According to an eighteenth embodiment, in one of the sixteenth and seventeenth embodiments, the movable unit 6 receives light at a height same as a height that the movable unit 6 outputs light. That is, the input collimators 11, the output collimators 12, the drop collimators 13, and the add collimators 14 are arranged at the same height. From an assembly point of view, light output and light input preferably have the same height, but not limited thereto.

According to a nineteenth embodiment, in the optical switch of one of the sixteenth to eighteenth embodiments, the fixed reflection mirror 4 is arranged so that the optical path is bent at the right angle. From an assembly point of view, it is preferred that the angle is the right angle, but not limited thereto.

In the embodiments of the present invention, the fixed reflection mirrors and the optical path move prisms are provided. The fixed reflection mirror is not limited to the mirror, and a penta-prism may be used as far as the prism is capable of bending the optical path. The optical path move prisms are not limited to the prisms, and a pair of mirrors may be arranged in parallel to move the optical path in parallel. The output and input collimators may be reversed. The fixing means are formed of the projections and the holes as a typical example, but not limited thereto.

The conventional optical switch requires stringent machining accuracy, positioning and angles for the optical elements and the driving device. On the other hand, in the optical switch of the present invention, it is possible to relax the requirements, thereby reducing cost and loss, and obtaining high yield. In the add/drop optical switch of the present invention, it is possible to drop (split) an optical signal from an input fiber to a specific drop fiber. Further, it is possible to add (insert) an optical signal from a specific add fiber to an output fiber.

1. An optical switching device for switching an optical path, comprising:
a fixed reflection element fixed at each of crossing points of a plurality of lines and a plurality of redundant lines for switching the optical path to one of the redundant lines, and
a movable optical unit disposed at each of the crossing points and including a first optical path parallel move element, said first optical path parallel move element having parallel surfaces for moving the optical path in parallel toward the fixed reflection element, wherein the movable optical unit located on the optical path of one of collimators moves in and out the optical path incident from an auxiliary collimator to switch the optical path when the one of the collimators has a problem.

2. An optical switching device for switching an optical path, comprising:
a fixed reflection element fixed at each of crossing points of a plurality of lines and a plurality of redundant lines for switching the optical path to one of the redundant lines,
a plurality of optical movable units disposed at predetermined ones of the crossing points, each of said movable optical units having a first optical path parallel move element having parallel surfaces for moving the optical path in parallel toward the fixed reflection element and a second optical path parallel move element having parallel surfaces for moving the optical path in parallel toward a position different from a reflection point of the fixed reflection element after the optical path is moved by the first optical path parallel move element and switched by the fixed reflection element, wherein one of the movable optical units located on the optical path of one of collimators moves in and out the optical path incident from an auxiliary collimator to switch the optical path when the one of the collimators has a problem.

3. The optical switching device according to claim 1, wherein said movable optical unit is disposed at one of the crossing points located on the optical path of the one of the collimators and moves in and out the optical path incident from the auxiliary collimator to switch the optical path when the one of the collimators has a problem.

4. The optical switching device according to claim 3, wherein said movable optical unit further includes a fixing member for fixing the movable optical unit to a specific one of the crossing points.

5. The optical switching device according to claim 4, wherein said movable optical switch further includes a projection for inserting into a hole disposed at the specific one of the crossing points so that the first optical path parallel move element of the movable optical unit is fixed to the specific one of the crossing points.

6. The optical switching device according to claim 1, wherein said movable optical unit located on the optical path of the one of the collimators moves vertically in and out the optical path incident from the auxiliary collimator to switch the optical path when the one of the collimators has a problem.

7. The optical switching device according to claim 2, wherein said first optical path parallel move element receives light at a height substantially same as that of light output from the second optical path parallel move element.

8. The optical switching device according to claim 1, wherein said fixed reflection element is arranged so that the optical path is bent substantially at a right angle.

9. An optical switch for switching an optical path, comprising:
a fixed reflection element for changing an angle of an optical path,
an optical path parallel move element having a pair of parallel surfaces for moving the optical path in parallel toward the fixed reflection element, and
driving means for moving the optical path parallel move element in parallel or rotating the same in and out the optical path to be switched.

10. An optical switch for switching an optical path, comprising:
a fixed reflection element for changing an angle of an optical path,
a first optical path parallel move element having a pair of parallel surfaces for moving the optical path in parallel toward the fixed reflection element,
a second optical path parallel move element having parallel surfaces for moving the optical path in parallel toward a position different from a reflection point of the fixed reflection element after the optical path is moved in parallel by the first optical path parallel move element and bent by the fixed reflection element, and
driving means for moving the first and second optical path parallel move elements in parallel or rotates the same in and out the optical path to be switched.

11. The optical switch according to claim 9, wherein said optical path parallel move element receives and outputs light at a same height.

12. the optical switch according to claim 10, wherein said driving means includes an integrated driving device for driving the first and second optical path parallel move elements.

13. The optical switch according to claim 9, wherein said fixed reflection element is arranged so that the optical path is bent substantially at the right angle.

14. The optical switch according to claim 9, wherein said optical switch includes an N number of the optical switches arranged in a line to form a 1×N optical switch.

15. The optical switch according to claim 9, wherein said optical switch includes an (M×N) number of the optical switches arranged in a matrix pattern to form an M×N matrix optical switch.

16. An add/drop optical switch for switching an optical path, comprising:
fixed reflection elements fixed at crossing points of optical paths of L pairs of opposite collimators formed of output collimators and input collimators, an M number of drop collimators, and an N number of add collimators for changing an angle of the optical paths,
an (L×(M+N)) number of movable optical units disposed at the crossing points, each of said movable optical units having at least one optical path move element having a pair of parallel surfaces, and
a driving device for moving at least one of the movable optical units in and out one of the optical paths so that light from one of the input collimators is switched to one of the drop collimators, and light from one of the add collimators is switched to one of the output collimators.

17. An add/drop optical switch for switching an optical path, comprising:
fixed reflection elements disposed at crossing points of optical paths of L pairs of opposite collimators formed of output collimators and input collimators, an M number of drop collimators, and an N number of Add collimators for changing an angle of the optical paths,
at least one movable optical unit disposed at one of the crossing points and having at least one optical path move elements having a pair of parallel surfaces,
a driving device for moving the movable optical unit to one of the crossing points in and out one of the optical paths so that light from one of the input collimators is switched to one of the drop collimators, and light from one of the add collimators is switched to one of the output collimators.

18. The optical switch according to claim 17, wherein said movable unit receives light at a height substantially same as that of light output from the movable unit.

19. The optical switch according to claim 17, wherein said fixed reflection elements are arranged so that the optical paths are bent substantially at a right angle.
